(19) United States
(12) Patent Application Publication
(10) Pub. No.: US 2021/0286720 A1
(43) Pub. Date: Sep. 16, 2021

(54) MANAGING SNAPSHOTS AND CLONES IN A SCALE OUT STORAGE SYSTEM

(71) Applicant: ORCA DATA TECHNOLOGY (XI'AN) CO., LTD, Xianyang (CN)

(72) Inventors: ARTHUR JAMES BEAVERSON, BOXBOROUGH, MA (US); BANG CHANG, CARY, NC (US)

(21) Appl. No.: 17/198,556

(22) Filed: Mar. 11, 2021

Related U.S. Application Data
(60) Provisional application No. 62/988,115, filed on Mar. 11, 2020.

(51) Int. Cl. G06F 12/02; G06F 12/0804

(52) U.S. Cl. CPC G06F 12/0246; G06F 12/0804; G06F 2212/7201; G06F 2212/466; G06F 12/0261

(57) ABSTRACT

Methods, systems, and media for supporting snapshots and clones in a scale out storage system are disclosed. The system maintains first metadata that maps logical addresses of logical data blocks to corresponding content IDs, a distributed hash table that maps content IDs to corresponding node IDs, and second metadata that maps content IDs to corresponding physical addresses of physical data blocks. Clones are created by mapping each logical block address of each clone to the content ID associated with its corresponding logical block address of the original and incrementing the reference counts in the second metadata. The task of incrementing reference counts in the second metadata can be distributed across multiple storage nodes. A logical device can be designated as a golden image. Clones of a golden image are created by decrementing its clone credit without incrementing the reference counts in the second metadata.

### CROSS-REFERENCE TO RELATED APPLICATION

This application claims priority to U.S. Provisional Patent Application No. 62/988,115, filed Mar. 11, 2020, which is hereby incorporated by reference herein in its entirety.

### TECHNICAL FIELD

The present disclosure relates generally to storage systems, and, more specifically, to managing snapshots and clones in a scale out storage system.

### BACKGROUND

A scale out storage system typically includes a plurality of nodes connected by a network. Each of the nodes may be equipped with a processor, a memory, and a number of storage devices. The storage devices may include hard disk drives (HDDs), solid-state devices (SSDs), or a combination of both (Hybrid). The storage devices may be configured under a RAID (Redundant Array of Inexpensive Disks) hardware or software for data redundancy and load balancing. The storage devices may be locally attached to each node or shared among multiple nodes. The processor may be dedicated to running storage software or shared between storage software and user applications. Storage software, such as a logical volume manager and a file system, provides storage virtualization and data services such as snapshots and clones.

Storage virtualization may decouple the logical devices addressed by user applications from the physical data placement on the storage devices. Storage virtualization allows the processor to optimize physical data placement based on the characteristics of the storage devices and provides capacity reduction such as data deduplication and compression. User applications address a logical device by its Logical Unit Number (LUN). A logical data block associated with a logical device is identified by a logical block number (LBN). Thus, a complete logical address for a logical data block comprises the LUN of the logical device and the LBN of the logical data block. To support storage virtualization, the processor translates each user I/O request addressed to a LUN/LBN to a set of I/O requests addressed to storage device IDs and physical block numbers (PBNs). That is, the storage software translates the logical addresses of the logical data blocks into corresponding physical addresses for the physical data blocks stored on the data storage devices. In some storage software implementations, to perform this translation, the processor maintains forward map metadata that maps each data block's LBN to its PBN.

A snapshot of a logical device may represent a frozen image of the logical device, hereinafter referred to as the original logical device or the original. When a snapshot is created at a point in time, it looks exactly like the original. As updates are made to the original, the snapshot remains the same and looks exactly like the original at the point in time when the snapshot was created.

Read-only snapshots may be used for data protection and data replication. In the case of data protection, the user can go to a snapshot to recover data in lieu of going to a tape backup of the original. The user can also revert the image of the original to that of a snapshot, hereinafter referred to as rollback. In the case of data replication, a snapshot is created and replicated to a tape or a remote location while the original is being actively updated by user applications.

Writable snapshots, commonly referred to as clones, can be used to create multiple working copies of data that can be independently modified. This is useful for creating test or development copies of production data for data analytics. Analytics applications can run against clones while the original is being actively updated by user applications.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

Methods and apparatus for supporting snapshots and clones in a scale out storage system are disclosed.

A method in accordance with some embodiments of the present disclosure may include: storing metadata mapping logical addresses associated with logical data blocks of one or more logical devices to physical addresses of physical data blocks stored in a plurality of data storage devices of a storage system. The metadata may include: first metadata mapping the logical addresses associated with the logical data blocks of the logical devices to a plurality of content identifiers, where a first logical data block of a first logical device of the logical devices is associated with a first logical address of the logical addresses and a first content identifier of the plurality of content identifiers, and where the first content identifier identifies content of the first logical data block; and second metadata mapping the content identifiers to the physical addresses of the physical data blocks, where the second metadata may include a first reference count indicative of the number of logical blocks associated with the first content identifier. The method also includes creating one or more clones of the first logical device, which may include: associating each of a plurality of logical addresses of the clones with the first content identifier, and updating the reference count based on the number of the clones. Other embodiments of this aspect include corresponding computer systems, apparatus, and computer programs recorded on one or more computer storage devices, each configured to perform the actions of the methods.

In some embodiments, the first metadata may include a first data entry mapping the first logical address to the first content ID, and where updating the reference count based on the number of the clones may include creating a second data entry mapping the second logical address to the first content id. Updating the first reference count based on the number of the clones may include incrementing the reference count by the number of the clones. Updating the first reference count based on the number of the clones may include: determining, based on the first content identifier, a node identifier identifying a node of the storage system; and sending, to the remote node, a request to update the first reference count based on the number of the clones in view of a determination that the node of the storage system is a remoted node.

In some embodiments, the method may further include: in view of a first change to the first logical data block, associating a second content identifier with the first logical address of the first logical data block; and updating the second metadata based on the second content identifier. Updating the second metadata based on the second content identifier may include: updating a second reference count in the second metadata to reflect the association between the second content identifier and the first logical address of the first logical data block, where the second reference count represents the number of logical blocks associated with the second content identifier. Updating the second metadata based on the second content identifier may include: creating, in the second metadata, a new entry that maps the second content identifier to a second physical address.

The method may further include: in view of a second change to a first clone of the first logical device, associating a third content identifier with a second logical address of the first clone; and updating the second metadata based on the third content identifier. Updating the third metadata based on the second content identifier may include: updating a third reference count in the second metadata to reflect the association between the third content identifier and the second logical address of the first clone, where the third reference count represents the number of logical blocks associated with the third content identifier. Updating the third metadata based on the second content identifier may include: creating, in the second metadata, a new entry that maps the third content identifier to a third physical address. The method may include: associating an image of a second logical device with a clone credit indicative of the maximum number of clones that may be created for the image of the second logical device; creating one or more clones of the image of the second logical device; and updating the clone credit based on the number of the clones of the image of the second logical device. Implementations of the described techniques may include hardware, a method or process, or computer software on a computer-accessible medium.

In accordance with one or more aspects of the present disclosure, a system is provided. The system includes a memory and a processor operatively coupled to the memory. The processor is configured to: store metadata mapping logical addresses associated with logical data blocks of one or more logical devices to physical addresses of physical data blocks stored in a plurality of data storage devices of a storage system. The metadata may include: first metadata mapping the logical addresses associated with the logical data blocks of the logical devices to a plurality of content identifiers, where a first logical data block of a first logical device of the logical devices is associated with a first logical address of the logical addresses and a first content identifier of the plurality of content identifiers, and where the first content identifier identifies content of the first logical data block. The metadata may also include second metadata mapping the content identifiers to the physical addresses of the physical data blocks, where the second metadata may include a first reference count indicative of the number of logical blocks associated with the first content identifier. The processor is further to create one or more clones of the first logical device, which may include: associating each of a plurality of logical addresses of the clones with the first content identifier, and updating the reference count based on the number of the clones.

One or more aspects of the present disclosure provide a non-transitory machine-readable storage medium including instructions that, when accessed by a processing device, cause the processing device to: store metadata mapping logical addresses associated with logical data blocks of one or more logical devices to physical addresses of physical data blocks stored in a plurality of data storage devices of a storage system. The metadata includes: first metadata mapping the logical addresses associated with the logical data blocks of the logical devices to a plurality of content identifiers, wherein a first logical data block of a first logical device of the logical devices is associated with a first logical address of the logical addresses and a first content identifier of the plurality of content identifiers, and wherein the first content identifier identifies content of the first logical data block; and second metadata mapping the content identifiers to the physical addresses of the physical data blocks, wherein the second metadata comprises a first reference count indicative of the number of logical blocks associated with the first content identifier. The processor is further to create one or more clones of the first logical device.

In some implementations, multiple requests to the same remote node to increment reference counts for multiple metadata blocks may be batched in a single request to reduce network latency.

In an implementation, a read-only snapshot and any write request on a read-only snapshot may be rejected.

In an implementation, the original logical device may be rolled back to one of its clones by comparing the content ID of each logical block address of the original logical device to that of the corresponding logical block address of the clone and changing the corresponding first metadata entry of the original logical device only when the two content IDs are different.

In an implementation, updates to the original logical device are logged before the cloning operations are completed. The logged updates are applied after the clones have been created.

### BRIEF DESCRIPTION OF THE DRAWINGS

The present disclosure is illustrated by way of example, and not by way of limitation, in the figures of the accompanying drawings, in which:

FIG. 1 is a block diagram illustrating an example of a scale out storage system in accordance with an implementation of the disclosure;

FIG. 2 is a block diagram illustrating metadata stored in the scale out storage system in accordance with an implementation of the disclosure;

FIG. 3A is a block diagram illustrating a storage system that may create a clone in accordance with an implementation of the disclosure;

FIG. 3B is a block diagram illustrating metadata in view of changes to the original in accordance with an implementation of the disclosure;

FIG. 3C is a block diagram illustrating example metadata in view of supporting changes to a clone, in accordance with an implementation of the disclosure;

FIG. 4 is a flow diagram illustrating an example method of creating clones in a data storage system, in accordance with an implementation of the disclosure;

FIG. 5 is a flow diagram illustrating an example method for managing clones of a logical device of a storage system in view of changes to an original logical device in accordance with some embodiments of the present disclosure;

FIG. 6 is a flow diagram illustrating an example method for managing clones of a logical device of a storage system in view of changes to a clone in accordance with an implementation of the disclosure;

FIG. 7 is a flow diagram illustrating an example method for managing clones of a logical device of a storage system utilizing a golden image in accordance with an implementation of the disclosure; and

FIG. 8 is a flow diagram illustrating an example of a process for updating a reference count associated with a content identifier in accordance with some embodiments of the present disclosure.

### DETAILED DESCRIPTION

Aspects of the present disclosure provide for mechanisms (e.g., methods, apparatuses, systems, media, etc.) for managing clones and snapshots in a storage system.

Prior solutions for creating a snapshot in a storage system typically involve mapping every LBN of the snapshot and the original to the same PBN in forward map metadata that maps each data block's LBN to its PBN. As a result of the creation of snapshots and clones, a significant number of LBNs are mapped to the same PBN in the forward map metadata. When a change is made to an LBN of the original, the original data may be copied to a new PBN and the LBN of the snapshot is mapped to the new PBN (copy on write) or the new data is written to a new PBN and the LBN of the original is mapped to the new PBN (redirect on write).

Supporting snapshots and clones using the forward map metadata is especially challenging in a scale out storage system. Data mobility is a fundamental requirement for a scale out storage system. One example of scale out operations is add-a-node where a new node is added to the storage system to provide more storage capacity and performance. Another example of scale out operations is remove-a-node where an existing node is removed from the storage system. In both cases, a large number of data blocks need to be moved from their current physical locations to new locations in order to redistribute data blocks across all available capacity and bandwidth. Data mobility is expected to be transparent to user applications. That is, a change in a data block's physical location should not affect its LUN/LBN addressed by user applications. In some storage software implementations, the processor maintains reverse map metadata that maps every physical data block's PBN to the LBNs that reference it. As part of moving a data block from PBN1 to PBN2, the processor first looks up PBN1 in the reverse map metadata to identify all the LBNs that reference PBN1. It then looks up these LBNs in the forward map metadata and changes their reference from PBN1 to PBN2. The processor then goes back to the reverse map metadata to change PBN1 to PBN2. Given that this data movement is not originated by a user application and therefore does not benefit from user application locality of reference, these numerous accesses to reverse map and forward map cannot be effectively cached in memory, causing the system to thrash.

To address the aforementioned and other deficiencies of the prior solutions, the present disclosure provide for mechanisms for supporting snapshots and clones in a scale out storage system are disclosed. The storage system is configured to support scale out, snapshots, and clones. The storage system may include a plurality of nodes connected by a network. Each node comprises a processor, a memory, and one or more storage devices. The storage system is configured to manage a storage pool, first metadata, a distributed hash table, and second metadata. The storage pool comprises storage devices from the plurality of nodes. The first metadata maps the logical address of each logical data block to a corresponding content ID. The first metadata entries are stored in metadata blocks. The distributed hash table maps each content ID to its corresponding node IDs based on load balancing and data redundancy policies. The second metadata maps content IDs on each node to corresponding physical addresses and maintains a reference count from the first metadata to each content ID. The metadata and the data blocks may be stored within the storage pool redundantly across the nodes and accessible by all the nodes. A logical data block is also referred to herein as a logical block. A physical data block is also referred to herein as a physical block.

To create N number of clones of an original logical device, the processors are configured to map in the first metadata each logical block address of each clone to the same content ID as the corresponding logical block address of the original and incrementing in the second metadata the reference count to the said content ID by N. Changes to the original do not affect its clones. Changes to one of the clones do not affect the original and its other clones.

In some implementations, a snapshot of a clone logical device may be designated as a read-only snapshot. In some implementations, the original logical device may be rolled back to one of its clones, such as a read-only snapshot. In some implementations, updates to the original are logged during the cloning operations and applied after the cloning operations are completed. In some implementations, the task of incrementing reference counts in the second metadata may be distributed across multiple nodes of the storage system. Multiple requests to the same remote node are batched to reduce network latency.

In some implementations, an image of a logical device may be designated as a golden image by incrementing the reference count of each content ID referenced by the said logical device by M, where M is referred to as the clone credit representing the number of clones to be created in the future. N clones of a golden image are created by decrementing its clone credit by N without changing the reference counts in the second metadata.

The present disclosure is not limited to the features, advantages, and contexts summarized above, and those familiar with storage technologies will recognize additional features and advantages upon reading the following detailed description and upon viewing the accompanying drawings.

Methods for supporting snapshots and clones more efficiently in a scale out storage system are disclosed. For purposes of this disclosure, similar elements are identified by similar numeric reference numbers. A numeric reference number followed by a lowercase letter refers to a specific instance of the element.

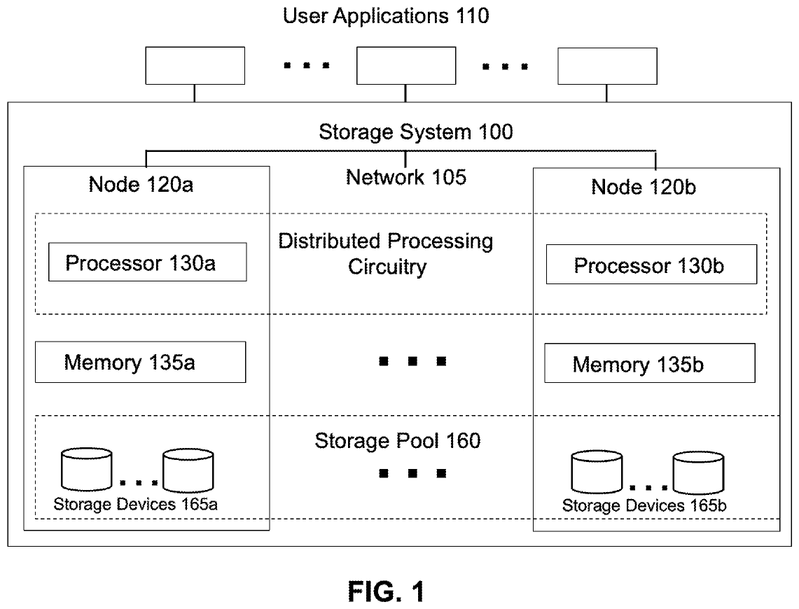

FIG. 1 is a block diagram illustrating an example 100 of a scale out storage system 100 in accordance with some implementations of the present disclosure. The scale out storage system 100 may include one or more nodes 120 connected by a network 105. In an implementation, network 105 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long-Term Evolution (LTE) network), routers, hubs, switches, server computers, the like, and/or a combination thereof.

In some embodiments, a node 120 may include a processor 130, a memory 135, and one or more storage devices 165. The processor 130 may include a microprocessor, microcontroller, digital signal processor, hardware circuit, firmware, the like, or a combination thereof. The processors 130 at each node 120 may collectively form a distributed processing circuitry that may control the storage system. Memory 135 may include volatile and/or non-volatile memory for locally storing information and data used by the node. The storage devices 165 at different nodes 120 within the storage system 100 may collectively form a shared data storage pool 160. Examples of storage devices 165 include solid-state devices (SSDs), hard disk drives (HDDs), and a combination of SSDs and HDDs (Hybrid).

In some embodiments, the storage devices 165 may be configured under a RAID system for data redundancy and load balancing. Examples of the RAID system may include software RAID, hardware RAID card, RAID on a chip, Erasure Coding, or JBOD (Just a Bunch of Disks). The storage devices 165 may also include a non-volatile random-access memory (NVRAM) device for write caching and deferred writes. Examples of NVRAM devices include NVRAM cards, battery-backed dynamic random-access memory (DRAM), and non-volatile dual in-line memory module (NVDIMM). In some implementations, the storage devices 165 may be accessible by multiple nodes 120 or multiple storage systems 100 as shared storage devices.

The storage system 100 may provide logical device access to one or more user applications 110. In some implementations, the user applications 110 and the storage system 100 may be running on the same physical systems. In other implementations, the user applications 110 may access the storage system 100 through a storage network such as Ethernet, FibreChannel, InfiniBand, and peripheral component interconnect express (PCIe) networks. The processors 130 may provide an interface between the user applications 110 and the storage devices 165. For example, the processors 130 may provide a set of commands for the application 110 to read from and write to the storage devices 165 in the storage pool 160. The processors 130 run storage software applications to provide storage virtualization and data services such as snapshots and clones that often cannot be achieved by the storage devices themselves.

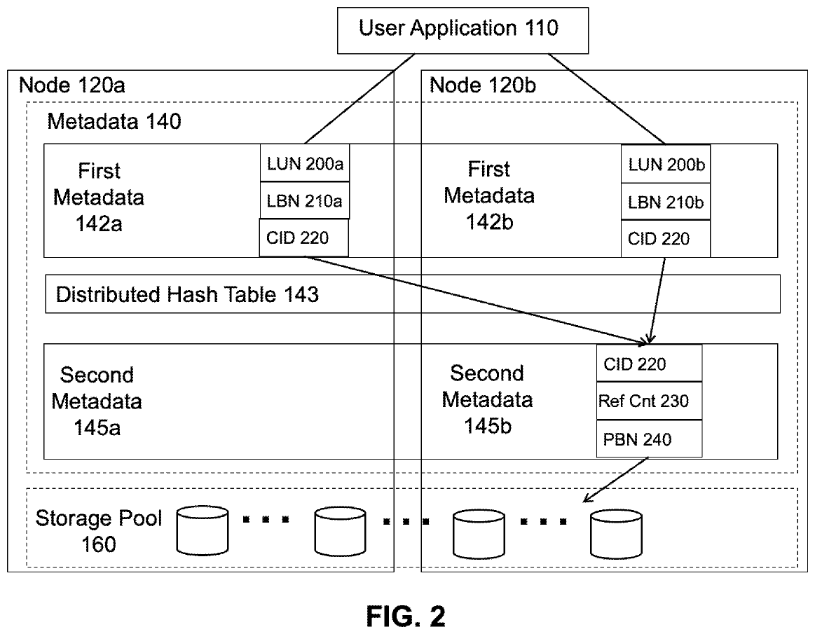

Metadata that may be used to manage various components of the storage system 100 may be stored on one or more nodes of the storage system 100. The metadata may map logical addresses associated with logical data blocks of logical devices of the storage system 100 to physical addresses of physical data blocks stored in the storage devices in the storage pool 160. For example, as shown in FIG. 2, metadata 140 may be stored, managed, processed, etc. on one or more nodes of storage system 100 (e.g., nodes 120a, 120b). The metadata 140 may include first metadata 142 (e.g., first metadata 142a, 142b), a distributed hash table (DHT) 143, and second metadata 145 (e.g., second metadata 145a, second metadata 145b).

The first metadata 142 may map the logical addresses associated with the logical data blocks of the logical devices to a plurality of content identifiers. Each of the content identifiers may identify the content of a logical data block. Multiple data block comprising the same content may be identified using the same content identifier. For example, the first metadata 142a on node 120a may map a first logical data block's LUN 200a and LBN 210a to a content ID (CID) 220. The content ID 220 may be a unique identifier identifying the content of the logical data block. The likelihood that two distinct blocks will have the same content ID is vanishingly small. In some embodiments, a second logical data block and the first logical data block may include the same content. In such embodiments, the second logical data block's LUN 200b and LBN 210b may be associated with the content ID 220. For example, the first metadata 142b on the node 120b may map LUN 200b and/or LBN 210b to the content ID 220.

In some implementations, a strong hash function, such as Secure Hash Algorithm 1 (SHA1) developed by the US National Institute for Standards and Technology (NIST), may be used to generate a content ID and make it computationally infeasible that two distinct blocks will have the same content ID. The first metadata entries may be stored in one or more metadata blocks. In some embodiments, a unique content ID may be generated for each of the metadata blocks.

The DHT 143 may be used to distribute data blocks and metadata blocks across the nodes 120 based on load balancing and/or data redundancy policies. Load balancing and data redundancy policies allow the distribution of data blocks while preventing network performance and availability issues. Network load balancing policies may provide for network redundancy and failover. DHT 143 may be used to provide a lookup service through which any participating node can retrieve the node IDs for any given content ID. In some implementations, responsibility for maintaining the mapping content IDs to node IDs may be distributed among the nodes 120 so that a change in the set of participating nodes 120 causes a minimal amount of disruption. This may allow the distributed hash table 143 to scale to extremely large numbers of nodes and to handle continual node arrivals, departures, and failures.

The second metadata may map the content identifiers to the physical addresses of the physical data blocks of the storage devices. For example, as shown in FIG. 2, on node 120b the second metadata 145b may map the CID 220 to its physical location PBN 240 on the storage devices. In some embodiments in which the logical data block associated with LUN 200a/LBN 210a on node 120a and the logical data block associated with LUN 200b/LBN 210b on node 120b have duplicate contents, both logical data blocks may be associated with the same CID 220.

The distributed hash table 143 may map node ID 120b to CID 220. On node 120b in the second metadata 145b CID 220 is mapped to PBN 240. Therefore, two logical data blocks LUN 200a/LBN 210a on node 120a and LUN 200b/LBN 210b are duplicated to one physical data block CID 220/PBN 240 on node 120b. It should be clear by this example that data deduplication is realized globally across all the LUNs 200 and all the nodes 120. The second metadata 145b may further include a Reference Count 230 that reflects the number of logical data blocks associated with CID 220.

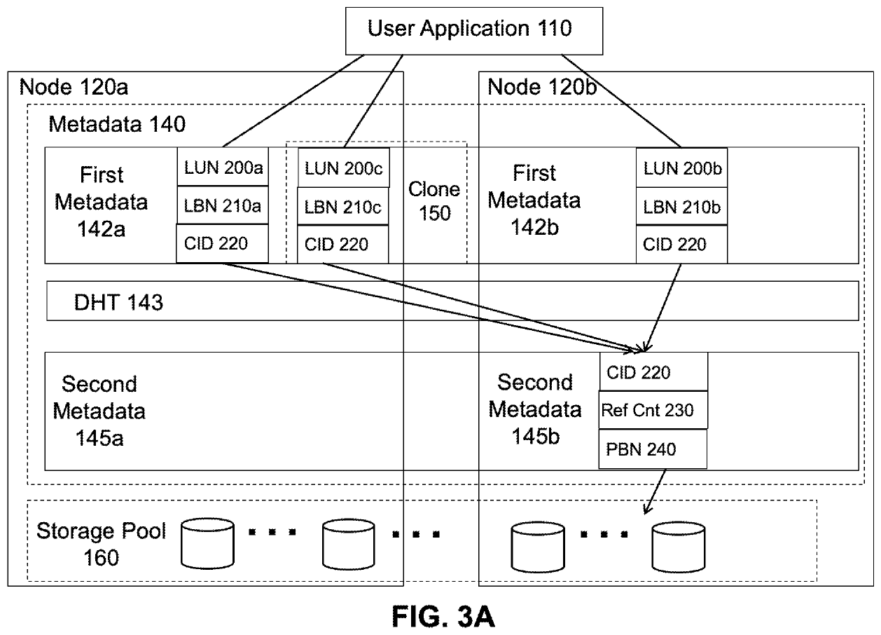

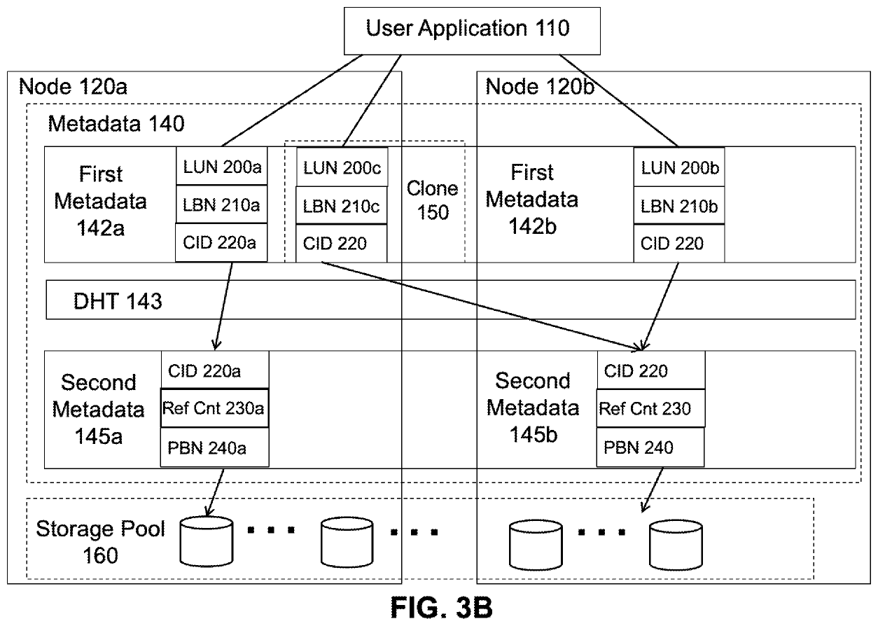

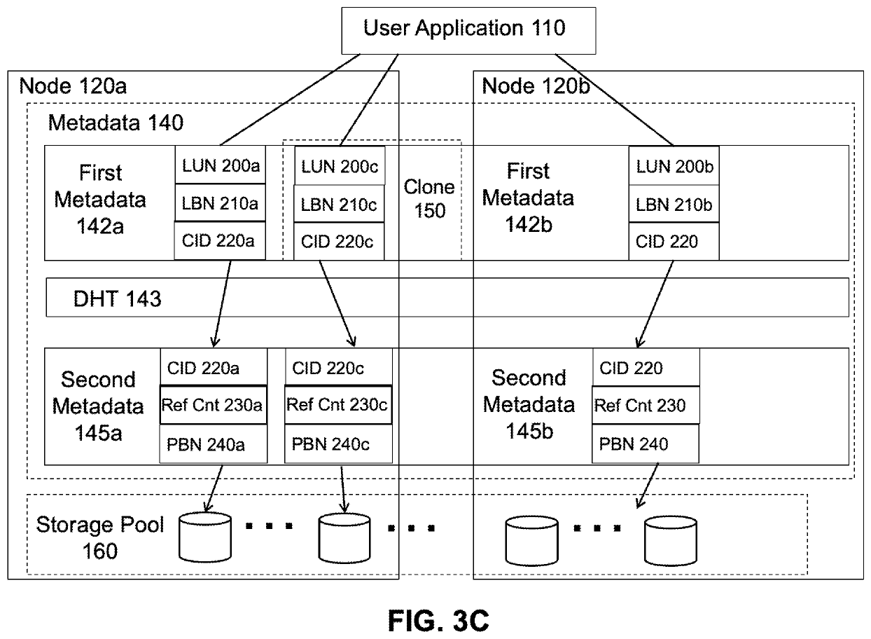

Processor 130 (e.g., processor 130a, 130b, etc.) may create and support clones for logical devices of the storage system 100. For example, a clone logical device may be created for the first logical device. The clone logical device may include one or more logical data blocks, each of which may correspond to a respective logical data block of the first logical device. A logical data block of the clone logical device and its corresponding logical data block of the first logical device may include the same content. Processor 130 may update the metadata 140 to create and/or support the clones. For example, as shown in FIG. 3A, a clone logical device associated with LUN 200c may be created for an original logical device associated with LUN 200a. A first logical data block of the clone logical device may correspond to a first logical data block of the original logical device. The first logical data block of the clone logical device and the first logical data block of the original logical device may include the same content and may be associated with the same content identifier. For example, as shown in FIG. 3A, the first metadata 142a may include a data entry that maps the logical address of the first logical data block of the clone logical device LUN 200c/LBN 200c to the content ID 220. The first metadata 142a may further include a data entry that maps the logical address of the first logical data block of the original logical device LUN 200a/LBN 200a to the content ID 220. The reference count 230 associated with CID 220 in the second metadata may be incremented by 1 to reflect the new reference from LUN 200c/LBN210c to the content ID CID 220.

Multiple clone logical devices may be created at the same time for the original logical device in a similar manner. For example, creating N clone logical devices of the original logical device may involve mapping each logical block address of the N clone logical devices to a content ID associated with its corresponding logical data block of the original logical device. Creating the clone logical devices may further involve incrementing the reference count associated with the content ID by N to reflect the new references from the clone logical devices to the content ID.

In some embodiments, one or more user applications 110 may make a change to one or more logical blocks of the original logical device. For example, the content of the logical block associated with LUN 200a/LBN 210a may be changed by one or more user applications 110. As illustrated in FIG. 3B, a different content ID CID 220a may be generated based on the changed block content. LUN 200a/LBN 210a may be mapped to CID 220a in the first metadata. The processor 130 and/or any other suitable component of the storage system 100 may determine whether there is an existing entry in the second metadata pertaining to CID 220a. If the second metadata does not include an existing entry corresponding to CID 220a, a new physical data block may be allocated from the storage pool 160 to store the new data block. In addition, a new entry (e.g., a new metadata block) mapping a physical address PBN 240a of the physical data block to CID 220a may be created in the second metadata 145a. If the second metadata includes an existing entry pertaining to CID 220a, the reference count 230a associated with CID 220a may be incremented by 1 to reflect the new reference from LUN 200a/LBN 210a to CID 220a. Accordingly, the clone logical device associated with LUN 200c is not affected by any change to the original logical device associated with LUN 200a.

In some embodiments, one or more user applications 110 may make a change to a logical data block of a clone logical device. For example, a change may be made to the content of the logical block associated with LBN210c of the clone logical device associated with LUN 200c. As illustrated in FIG. 3C, a content ID CID 220c may be generated based on the changed block content. CID 220c may be different from CID 220. In addition, LUN 200c/LBN 210c may be mapped to CID 220c in the first metadata. If the second metadata 145a does not include an existing entry corresponding to CID 220c, a new physical data block may be allocated from the storage pool 160 to store the content of the changed logical data block. Furthermore, a new entry that maps CID 220c to the physical address of the physical data block PBN 240c may be created in the second metadata 145a. If there is an existing entry in the metadata 145a pertaining to CID 220c (e.g., an entry mapping CID 220c to PBN 240c), the reference count 230c associated with CID 220c may be incremented by 1 to reflect the new reference from LUN 200c/LBN 210c to CID 220c. Accordingly, the original logical device associated with LUN 200a is not affected by any change to the clone logical device associated with LUN 200c.

Suppose that a first user of user application 110 is reading or writing data represented by first metadata with LUN 200a, LBN 210a, and CID 220 in Node 120a. A second user of user application 110 may be manipulating, for purposes of cloning data represented by first metadata with LUN 200b, LBN 210b, and CID 220. When a third user of user application 110 may wish to modify the data represented by CID 200 independently from the first user and the second user, clone 150 in FIG. 3B is created.

In some implementations, a snapshot of a clone logical device may be designated as a read-only snapshot. A write request on a read-only snapshot is rejected. In some implementations, an original logical device can be rolled back to one of its clones, such as a read-only snapshot, by comparing the content ID of each logical block address of the original logical device to that of the corresponding logical block address of the clone logical device and changing the corresponding first metadata entry of the original only when the two content IDs are different.

During the creation of clones, the user application(s) 110 need to be paused/quiesced from making changes to the original until the cloning operations are completed. This quiesce period needs to be short enough, typically in a matter of seconds, so the user applications 110 do not have time out or fail user requests. In some implementations, during the cloning operations, updates to the original are logged. The logged updates may be applied to the original after the cloning operations are completed.

In some implementations, when a logical device is expected to be cloned in the future, an image of the logical device may be designated as a golden image. A reference count M may be associated with the golden image. The reference count M (also referred to as the “clone credits”) may indicate the maximum number of clones that may be created for the golden image. In some embodiments, creating the golden image may involve incrementing the reference count of each content ID referenced to by the logical device by the reference count M. To create a clone of the golden image, the reference count M may be decremented by 1 to indicate that the maximum number of clones that may be created for the golden image is M−1. In some embodiments, multiple clones of the golden image may be created sequentially, in parallel, etc. For example, N clones of the golden image may be created by decrementing the clone credits associated with the golden image by N without incrementing the reference counts in the second metadata. The golden image can be deleted by decrementing the reference count of each content ID referenced to by the golden image by its remaining clone credit.

There are several user-visible features that require adjusting reference counts on a Merkle tree (mtree). This includes creating and deleting snapshots and clones where reference counts are be added or subtracted. An mtree is a hash tree or a tree in which every leaf node is identified with the cryptographic hash of a data block, and every non-leaf node is identified with the cryptographic hash of the ID of its child nodes. Arranged in a hierarchical arrangement in the form of a tree, leaf nodes are at the same level as one another and have no child nodes and non-leaf nodes have dependent child nodes.

In order to adjust reference counts, all mtree nodes may have to eventually be read in, and each mtree node must be scanned for all 204 object signatures, and the signature reference count adjusted. A signature is an identification in a cryptographic hash. The algorithm to adjust reference counts recurses until the bottom of the tree is reached, and all payload reference counts have been updated.

In many instances, there may not be enough memory to hold the entire mtree. For example, an 8 terabyte (TB) system has roughly 40 gigabytes (GB) (0.05%) of mtree data. In this instance, it does not make any difference how many LUNS that data is spread across, the size of mtree data is still the same. A 1 TB LUN has 5 GB of metadata. Given that the mtree is very flat (e.g., having a large fanout), almost all of the data (about 99.5%) is at the bottom of the tree. A fanout, in any tree, is number of pointers to child nodes in a node. Therefore, the algorithm may be able to cache internal nodes, (for example, about 25 MB for the 1 TB LUN), but not all nodes.

An algorithm could be designed to allow an individual CPU to traverse the entire mtree, causing a large portion of the mtree to be copied to another memory space or read over the network. However, this is a relatively expensive operation in terms of time consumption of the hardware and/or software used to perform the steps of algorithm and the network bandwidth. Using the 1 TB example if an individual CPU would traverse the entire tree, an mtree algorithm would need to read in 5 GB of data. Assuming that the read would not be able to take all of the backend bandwidth. Assume the bandwidth is 50 MB/sec. At that rate, it will take 100 seconds just to read in the data. If 100% of the reference count updates are pipelined to be performed (i.e., queued), a lower bound on a mtree update would be represented.

One solution for an efficient snapshots and clones support is to perform the mtree operation in parallel across a storage system. Each node in the storage system operates only on objects that it owns, per the DHT. Thus, no mtree objects are transmitted across the storage system. Instead, the reference updates, which are significantly smaller than payload, are transmitted.

Each node may have an mtree server process as outlined in the following algorithm:

```
While (1) {
  Wait for a work item (node_signature, tree level)
  If (node_signature doesn't belong to me) continue
  Read in object corresponding to node_signature,
  treat as an mtree node
  For (each signature in mtree node)
  If (level) {
    Send work item (signature, level-1) to first node
    in placement group for signature
    Wait for response
  }else {
    Adjust signature reference
  }
    Respond to original work item
}
}
```

Assuming snapshots and/or clones rarely happen, in the above algorithm, objects may be uniformly distributed across the storage system per the DHT. The entire storage system (e.g., storage system 100) participates in processing the mtree. Although mtree data is read-only in this algorithm, all of the mtree data is local and evenly distributed and only reference updates are transmitted.

The algorithm described may introduce a great deal of parallelism and may guarantee that all mtree metadata reads are local. Furthermore, to support larger storage systems, reference updates may be transmitted in bulk. For example, a 20 GB mtree may require over 5 million network operations for reference updates. A 4 Kilobytes data is used to update references and accumulated network latency of the whole storage system which may be reduced by a significant amount when reference updates are done in bulk.

Snapshots and clones require a consistent, persistent copy of the source mtree. Writes to the mtree change the mtree but those changes do not take effect until the metadata log is flushed (or metadata log is synchronized). By deferring the flush of the metadata log until the cloning operation is completed, the amount of time of blocking storage system input and output (I/O) to the mtree is minimized.

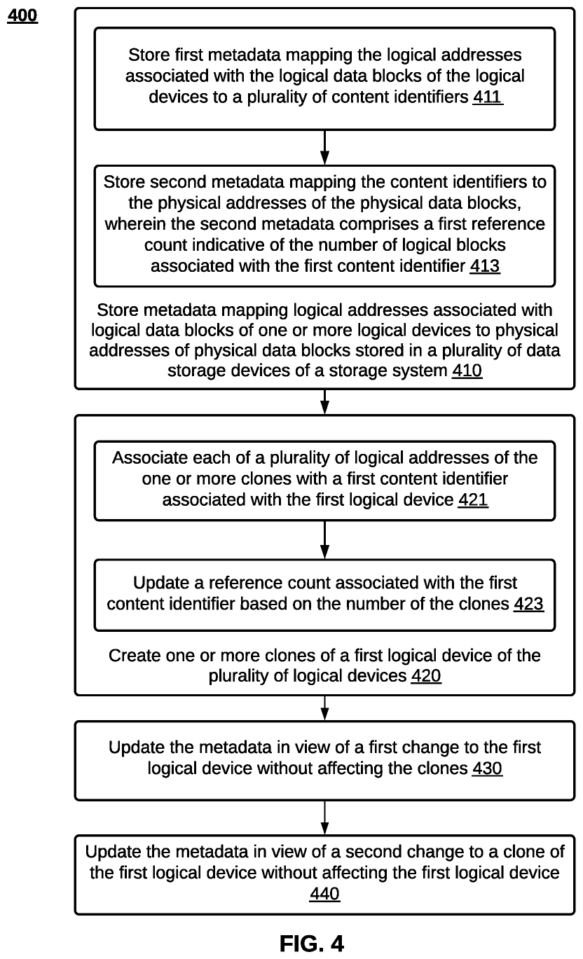

FIG. 4 is a flow diagram illustrating an example 400 of a process for creating clones of a logical device of a storage system in accordance with some embodiments of the present disclosure. Method 400 may be performed by one or more processors of the storage system 100 which may include hardware (e.g., circuitry, dedicated logic, programmable logic, microcode, etc.), software (e.g., instructions run on a processing device to perform hardware simulation), or a combination thereof.

Process 400 may start at 410, where a processor may store metadata mapping logical addresses associated with logical data blocks of one or more logical devices to physical addresses of physical data blocks stored in a plurality of data storage devices of a storage system. The metadata may include, for example, metadata 140 of FIGS. 2-3C. As an example, storing the metadata may include storing first metadata mapping the logical addresses associated with the logical data blocks of the logical devices to a plurality of content identifiers at block 411. The first metadata may include, for example, first metadata 142a and/or first metadata 142b of FIGS. 2-3C. As another example, storing the metadata may include storing second metadata mapping the content identifiers to the physical addresses of the physical data blocks at 413. The second metadata may include, for example, second metadata 145a and/or second metadata 145b of FIGS. 2-3C.

At block 420, one or more clones of a first logical device of the plurality of logical devices may be created. Each of the clones may correspond to a snapshot of the first logical device. Each of the clones of the first logical device may include one or more logical blocks corresponding to the logical blocks of the first logical device. For example, a first logical block of a first clone may correspond to a first logical block of the first logical device. The first logical block of the first clone and the first logical block of the first logical device may include the same content. As an example, a second logical block of a first clone may correspond to a second logical block of the first logical device. The second logical block of the first clone and the second logical block of the first logical device may include the same content. As another example, a first logical block of each of the plurality of clones may correspond to the first logical block of the first logical device.

In some embodiments, creating the one or more clones of the first logical device may include associating each of a plurality of logical addresses of the one or more clones with a first content identifier associated with the first logical device at block 421.

In some embodiments, creating the one or more clones of the first logical device may include updating a reference count associated with the first content identifier based on the number of the clones at block 423. For example, in some embodiments in which N clones are created, the reference count may be incremented by N. N may be 1, 2, . . . , or any other suitable integer that may represent the number of the clones.

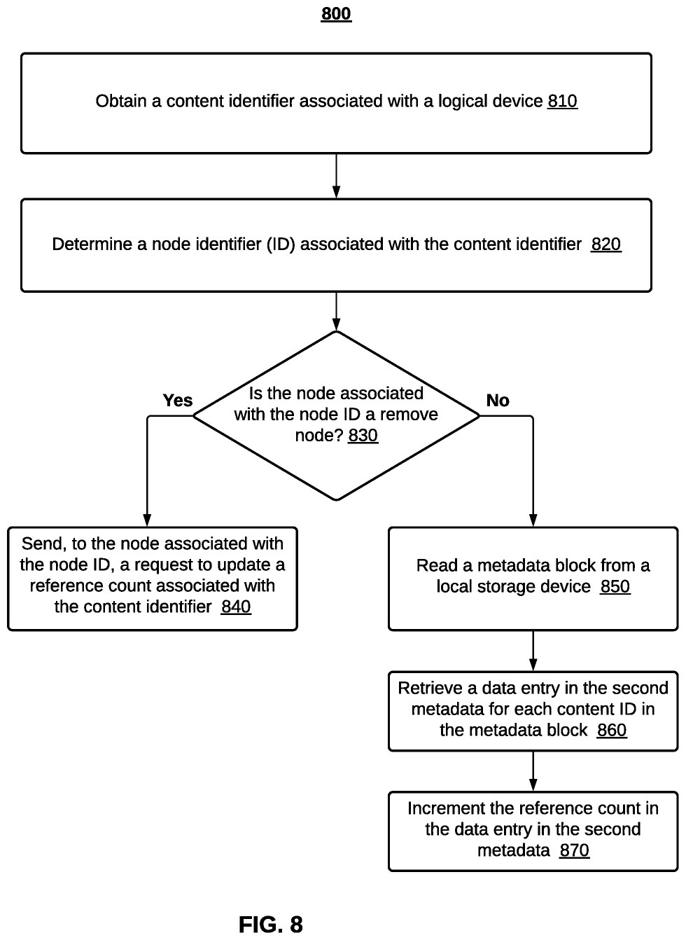

In some implementations, the task of incrementing the reference counts in the second metadata may be distributed across multiple storage nodes to further enhance the efficiency of the storage system during the creation of the clones. For example, the processor may reside on a first node and may increment a reference count associated with a content identifier in the second metadata if the second metadata entry pertaining to the reference count is stored in a local storage device (e.g., a storage device residing on the first node). If the second metadata pertaining to the reference count is store in a remote node (e.g., a second node of the storage system that is different from the first node), the processor may send, to the remote node, a request for incrementing the reference count. In some embodiments, to determine whether the second metadata entry pertaining to the reference count is stored in a local storage device, the processor may determine a node identifier associated with the content identifier (e.g., by looking up the node identifier in the DHT 143). The process may then compare the node identifier with the node identifier of the first node to determine whether the node identifier is associated with a remote node. In some embodiments, updating the reference count may involve performing one or operations as described in connection with FIG. 8 below.

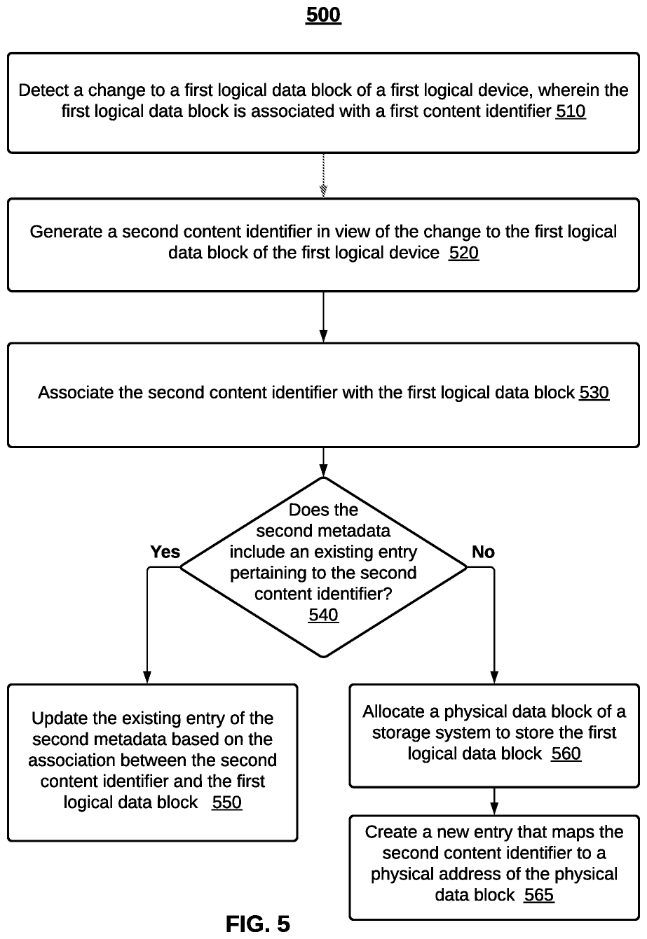

In some embodiments, at block 430, the processor may update the metadata in view of a first change to the first logical device without affecting the clones. For example, the processor may generate a new content identifier in view of the first change to the first logical device and may associate the new content identifier with the first logical device. In some embodiments, updating the metadata in view of the first change may involve performing one or more operations as described in connection with FIG. 5.

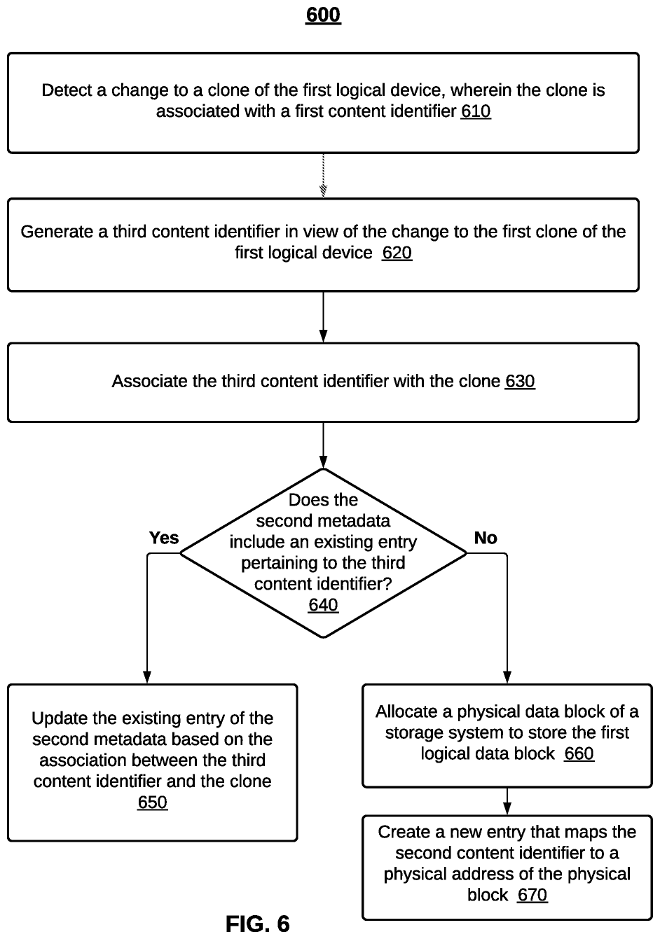

In some embodiments, at block 440, the processor may update the metadata in view of a second change to a clone of the first logical device without affecting the first logical device. For example, the processor may generate a new content identifier in view of the second change to the clone and may associate the new content identifier with the clone. In some embodiments, updating the metadata in view of the second change may involve performing one or more operations as described in connection with FIG. 6. In some embodiments, block 430a and/or 440 may be omitted.

FIG. 5 is a flow diagram illustrating an example 500 of a process for managing clones of a logical device of a storage system in accordance with some embodiments of the present disclosure.

Process 500 may start at block 510, wherein a processor may detect a change to a first logical data block of a first logical device. The first logical data block is associated with a first content identifier. As an example, as described in connection with FIG. 3A, the first logical data block may be associated with LUN 200a/LBN 210a and CID 220. The change may be any suitable change to the content of the first logical data block. In some embodiments, the change may be made by one or more user applications as described herein.

At block 520, the processor may generate a second content identifier in view of the change to the first logical data block of the first logical device. For example, as described in connection with FIG. 3B, CID 220a may be generated based on the changed content of the first logical data block.

At block 530, the processor may associate the second content identifier with the first logical data block. For example, the processor may generate and/or store metadata that maps a logical address of the first logical data block to the second content identifier. The logical address of the first logical data block may be and/or include a LUN, an LBN, etc. In some embodiments, as described in connection with FIG. 3B, the first metadata 142a may be updated to include data that maps LUN 200a/LBN 210a to CID 220a.

At block 540, the processor may determine whether the second metadata includes an existing entry pertaining to the second content identifier. In some embodiments, the processor may proceed to block 550 in response to determining that an existing entry of the first metadata pertaining to the second content identifier. At block 550, the processor may update the existing entry of the second metadata based on the association between the second content identifier and the first logical data block. For example, a reference count associated with the second content identifier may be incremented by 1 to reflect the association between the second content identifier and the first logical data block. The reference count may represent the number of logical blocks associated with the second content identifier (e.g., Ref Cnt 230a of FIG. 3B).

In some embodiments, the processor may proceed to block 560 in response to determining that the first metadata does not include an existing entry pertaining to the second content identifier. At block 560, the processor may allocate a physical data block of a storage system to store the first logical data block.

At block 565, the processor may create, in the second metadata, a new entry that maps the second content identifier to a physical address of the physical data block. For example, as described in connection with FIG. 3B, a new entry (e.g., a new metadata block) may be created in the second metadata 145a to map CID 220a to PBN 240a. The second metadata 145a may further include a reference count 230a indicative of the number of logical blocks associated with the second content identifier.

FIG. 6 is a flow diagram illustrating an example 600 of a process for managing clones of a logical device of a storage system in view of changes to a clone of the logical device in accordance with some embodiments of the present disclosure.

Process 600 may start at block 610, wherein a processor may detect a change to a logical data block of a clone of the first logical device. The logical data block of the clone may be associated with a first content identifier. The logical data block of the clone may correspond to a first logical data block of the first logical device. Both the logical data block of the clone and the first logical data block of the first logical device may be associated with the first content identifier. For example, as described in connection with FIG. 3A, the logical data block of the clone may be associated with LUN 200c/LBN 210c and CID 220.

At block 620, a third content identifier may be generated in view of the change to the logical data block of the first logical device.

At block 630, the third content identifier may be associated with the logical data block of the clone. For example, first metadata mapping the logical address of the logical data block to the third content identifier may be generated and/or stored.

At block 640, the processor may determine whether the second metadata includes an existing entry pertaining to the third content identifier. In some embodiments, in response to determining that the second metadata includes an existing entry pertaining to the third content identifier, the processor may proceed to block 650. At block 650, the processor may update the existing entry of the second metadata based on the association between the third content identifier and the logical data block of the clone. For example, a reference count associated with the third content identifier may be incremented by 1 to reflect the association between the third content identifier and the logical data block of the clone. The reference count may represent the number of logical blocks associated with the third content identifier (e.g., Ref Cnt 230c of FIG. 3C).

In some embodiments, the processor may proceed to block 660 in response to determining that the second metadata does not include an existing entry pertaining to the third content identifier. At block 660, the processor may allocate a physical data block of a storage system to store the logical data block of the clone.

At block 670, the processor may create, in the second metadata, a new entry that maps the third content identifier to a physical address of the physical data block. For example, as described in connection with FIG. 3C, a new entry (e.g., a new metadata block) may be created in the second metadata 145a to map CID 220c to PBN 240c. The second metadata 145a may further include a reference count 230c indicative of the number of logical blocks associated with the third content identifier.

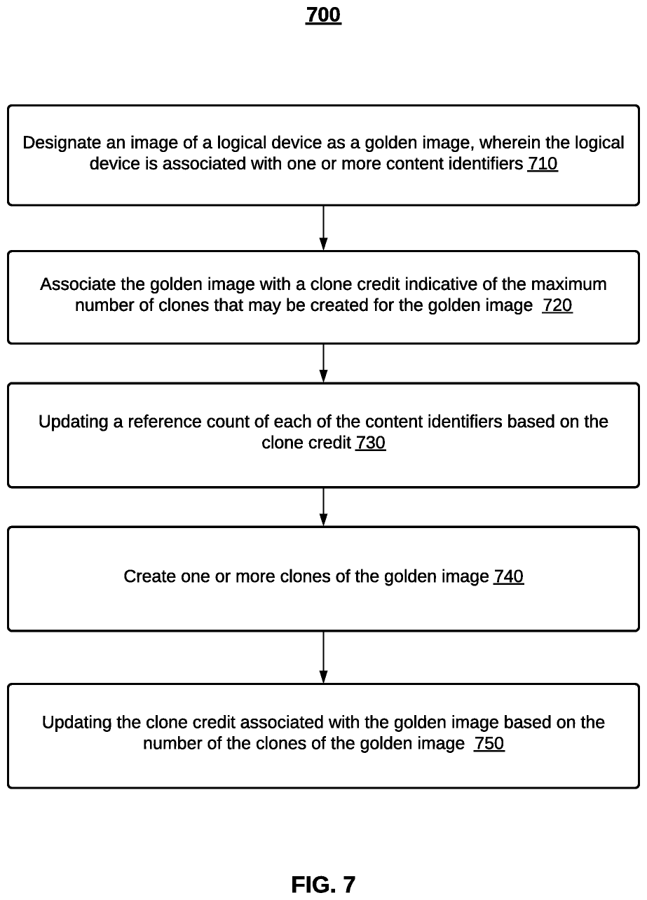

FIG. 7 is a flow diagram illustrating an example 700 of a process for managing clones of a logical device in a storage system using a golden image in accordance with some embodiments of the present disclosure.

Process 700 may start at block 710, where a processor may designate an image of a logical device as a golden image. The logical device may be associated with one or more content identifiers. For example, the logical device may include one or more logical data blocks. Each of the logical data blocks may be associated with a unique content identifier identifying the content of the logical data block. The content identifier may be associated with a reference count indicative of the number of logical data blocks associated with the content identifier.

At block 720, the processor may associate with the golden image with a clone credit indicate of the maximum number of clones that may be created for the golden image. For example, the clone credit may be stored in association with a logical address of the logical device in the first metadata. The first metadata may then include one or more data entries that map the logical address of the logical device to the clone credit.

At block 730, the processor may update a reference count of each of the content identifiers based on the clone credit. For example, the processor may increment the reference count of each content identifier by the value of the clone credit.

At block 740, the processor may create one or more clones of the golden image. The clones may be created, for example, by performing one or more operations as described in connection with FIG. 4 above.

At block 750, the processor may update the clone credit associated with the golden image based on the number of the clones of the golden image. For example, the value of the clone credit may be decremented by the number of the clones created at block 740.

FIG. 8 is a flow diagram illustrating an example 800 of a process for updating a reference count associated with a content identifier in accordance with some embodiments of the present disclosure. Method 800 may be performed by one or more processors of storage system 100 which may include hardware (e.g., circuitry, dedicated logic, programmable logic, microcode, etc.), software (e.g., instructions run on a processing device to perform hardware simulation), or a combination thereof.

At 810, a processor of a first node of a storage system may obtain a content identifier associated with a logical device. The logical device may be an original logical device and/or the first logical device as described herein. The content identifier may be a unique identifier that identifies the content of one or more logical data blocks of the logical device. For example, CID 220 for first metadata 142a may be obtained.

At 820, the processor may determine a node identifier (ID) associated with the content identifier. For example, the processor may look up the node ID in a DHT containing information that maps a plurality of node identifiers to a plurality of content identifiers. Each of the node identifiers may uniquely identify a node of the storage system. As an example, the DHT may be and/or include DHT 143 of FIGS. 2-3C. The processor may look up a node ID associated with CID 220 in the DHT 143.

At 830, the processor may determine whether a node associated with the node ID is remote For example, the processor may determine that the node associated with the node ID is remote in response to determining that the node ID associated with the content ID is not the same as the node ID of the first node. In response to determining that the node associated with the node ID is remote, the method may proceed to block 840. Alternatively, the method may proceed to block 850 in view of a determination that the node associated with the node ID is not remote.

At 840, the processor may send, to the node associated with the node ID, a request to update a reference count associated with the content identifier. The reference count may be updated, for example, by incrementing the reference count in the second metadata stored on the node based on the number of clones of the logical device. As an example, the processor may transmit a request to node 120b to increment reference count Ref Cnt 230 in second metadata 145b. One or more processors of node 120b may then increment the reference count in view of the request (e.g., by performing one or more operations depicted in blocks 850-870).

At 850, a metadata block may be read from a local storage device. For example, first metadata 142b may be read from a storage device on the node 120b.

At 860, one or more data entries in the second metadata may be retrieved for each content ID in the metadata block. For example, the processor of the first node may retrieve second metadata 145b for CID 220 in first metadata 142a and first metadata 142b.

At 870, the reference count in the second metadata entry is incremented. For example, storage system 100 increments the reference count Ref Cnt 230 in second metadata 145b.

In the foregoing description, numerous details are set forth. It may be apparent, however, that the disclosure may be practiced without these specific details. In some instances, well-known structures and devices are shown in block diagram form, rather than in detail, in order to avoid obscuring the disclosure.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the following discussion, it is appreciated that throughout the description, discussions utilizing terms such as “receiving,” “storing,” “generating,” “determining,” “sending,” “updating,” “incrementing,” “maintaining,” “identifying,” “associating,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a machine-readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems may appear as set forth in the description below. In addition, the disclosure is not described with reference to any particular programming language. It may be appreciated that a variety of programming languages may be used to implement the teachings of the disclosure as described herein.

The disclosure may be provided as a computer program product, or software, that may include a machine-readable storage medium having stored thereon instructions, which may be used to program a computer system (or other electronic devices) to perform a process according to the disclosure. A machine-readable storage medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), etc.

For purposes of this disclosure, any element mentioned in the singular also includes the plural.

Although some figures depict lines with arrows to represent intra-network or inter-network communication, in other implementations, additional arrows may be included to represent communication. Therefore, the arrows depicted by the figures do not limit the disclosure to one-directional or bi-directional communication.

Whereas many alterations and modifications of the disclosure may no doubt become apparent to a person of ordinary skill in the art after having read the foregoing description, it is to be understood that any particular example shown and described by way of illustration is in no way intended to be considered limiting. Therefore, references to details of various examples are not intended to limit the scope of the claims, which in themselves recite only those features regarded as the disclosure.

What is claimed is:

1. A method, comprising:
storing metadata mapping logical addresses associated with logical data blocks of one or more logical devices to physical addresses of physical data blocks stored in a plurality of data storage devices of a storage system, the metadata comprising:
first metadata mapping the logical addresses associated with the logical data blocks of the one or more logical devices to a plurality of content identifiers, wherein a first logical data block of a first logical device of the logical devices is associated with a first logical address of the logical addresses and a first content identifier of the plurality of content identifiers, and wherein the first content identifier identifies content of the first logical data block; and
second metadata mapping the content identifiers to the physical addresses of the physical data blocks, wherein the second metadata comprises a first reference count indicative of the number of logical data blocks associated with the first content identifier; and
creating one or more clones of the first logical device, comprising:
associating each of a plurality of logical addresses of the clones with the first content identifier; and
updating the first reference count based on the number of the clones.

2. The method of claim 1, wherein the first metadata comprises a first data entry mapping the first logical address to the first content identifier, and wherein updating the reference count based on the number of the clones comprises creating a second data entry mapping the first logical address to the first content ID.

3. The method of claim 1, wherein updating the first reference count based on the number of the clones comprises incrementing the reference count by the number of the clones.

4. The method of claim 3, wherein updating the first reference count based on the number of the clones further comprises:
determining, based on the first content identifier, a node identifier identifying a node of the storage system; and
sending, to the node of the storage system, a request to update the first reference count based on the number of the clones in view of a determination that the node of the storage system is a remoted node.

5. The method of claim 1, further comprising:
in view of a first change to the first logical data block, associating a second content identifier with the first logical address of the first logical data block; and
updating the second metadata based on the second content identifier.

6. The method of claim 5, wherein updating the second metadata based on the second content identifier comprises:
updating a second reference count in the second metadata to reflect the association between the second content identifier and the first logical address of the first logical data block, wherein the second reference count represents the number of logical data blocks associated with the second content identifier.

7. The method of claim 5, wherein updating the second metadata based on the second content identifier comprises:
creating, in the second metadata, a new entry that maps the second content identifier to a second physical address.

8. The method of claim 5, further comprising:
in view of a second change to a first clone of the first logical device, associating a third content identifier with a second logical address of the first clone; and
updating the second metadata based on the third content identifier.

9. The method of claim 8, wherein updating the second metadata based on the second content identifier comprises:
updating a third reference count in the second metadata to reflect the association between the third content identifier and the second logical address of the first clone, wherein the third reference count represents the number of logical blocks associated with the third content identifier.

10. The method of claim 8, wherein updating the third metadata based on the second content identifier comprises:
creating, in the second metadata, a new entry that maps the third content identifier to a third physical address.

11. The method of claim 1, further comprising:
associating an image of a second logical device with a clone credit indicative of the maximum number of clones to be created for the image of the second logical device;
creating one or more clones of the image of the second logical device; and
updating the clone credit based on the number of the clones of the image of the second logical device.

12. A system, comprising:
a memory; and
a processor operatively coupled to the memory, the processor to:
store metadata mapping logical addresses associated with logical data blocks of one or more logical devices to physical addresses of physical data blocks stored in a plurality of data storage devices of a storage system, the metadata comprising:
first metadata mapping the logical addresses associated with the logical data blocks of the logical devices to a plurality of content identifiers, wherein a first logical data block of a first logical device of the logical devices is associated with a first logical address of the logical addresses and a first content identifier of the plurality of content identifiers, and wherein the first content identifier identifies content of the first logical data block; and
second metadata mapping the content identifiers to the physical addresses of the physical data blocks, wherein the second metadata comprises a first reference count indicative of the number of logical data blocks associated with the first content identifier; and
create one or more clones of the first logical device, comprising:
associate each of a plurality of logical addresses of the clones with the first content identifier; and
update the reference count based on the number of the clones.

13. The system of claim 12, wherein the first metadata comprises a first data entry mapping the first logical address to the first content ID, and wherein, to update the reference count based on the number of the clones, the processor is to create a second data entry mapping the first logical address to the first content ID.

14. The system of claim 12, wherein updating the first reference count based on the number of the clones comprises incrementing the reference count by the number of the clones.

15. The system of claim 14, wherein, to update the first reference count based on the number of the clones, the processor is to:
determine, based on the first content identifier, a node identifier identifying a node of the storage system; and
send, to the node of the storage system, a request to update the first reference count based on the number of the clones in view of a determination that the node of the storage system is a remoted node.

16. The system of claim 12, wherein the processor is further to:
in view of a first change to the first logical data block, associate a second content identifier with the first logical address of the first logical data block; and
update the second metadata based on the second content identifier.

17. The system of claim 16, wherein the processor is further to:
in view of a second change to a first clone of the first logical device, associate a third content identifier with a second logical address of the first clone; and
update the second metadata based on the third content identifier.

18. The system of claim 12, wherein the processor is further to:
associate an image of a second logical device with a clone credit indicative of the maximum number of clones to be created for the image of the second logical device;
create one or more clones of the image of the second logical device; and
update the clone credit based on the number of the clones of the image of the second logical device.

19. A non-transitory machine-readable storage medium including instructions that, when accessed by a processor, cause the processor to:
store metadata mapping logical addresses associated with logical data blocks of one or more logical devices to physical addresses of physical data blocks stored in a plurality of data storage devices of a storage system, the metadata comprising:
first metadata mapping the logical addresses associated with the logical data blocks of the logical devices to a plurality of content identifiers, wherein a first logical data block of a first logical device of the logical devices is associated with a first logical address of the logical addresses and a first content identifier of the plurality of content identifiers, and wherein the first content identifier identifies content of the first logical data block; and
second metadata mapping the content identifiers to the physical addresses of the physical data blocks, wherein the second metadata comprises a first reference count indicative of the number of logical data blocks associated with the first content identifier; and
create one or more clones of the first logical device, comprising:
associate each of a plurality of logical addresses of the clones with the first content identifier; and
update the reference count based on the number of the clones.

20. The non-transitory machine-readable storage medium of claim 19, wherein the processor is further to:
associate an image of a second logical device with a clone credit indicative of the maximum number of clones to be created for the image of the second logical device;
create one or more clones of the image of the second logical device; and
update the clone credit based on the number of the clones of the image of the second logical device.
